(19) United States
(12) Patent Application Publication
(10) Pub. No.: US 2024/0286066 A1
(43) Pub. Date: Aug. 29, 2024

(54) 3D Printed Bubble Traps and Methods of Manufacture

(71) Applicant: LIFE TECHNOLOGIES CORPORATION, Carlsbad, CA (US)

(72) Inventors: Scott T. Hanks, Carlsbad, CA (US); Steven R. KJAR, Carlsbad, CA (US)

(21) Appl. No.: 18/692,700

(22) PCT Filed: Sep. 16, 2022
(86) PCT No.: PCT/US2022/076542

§ 371 Date: Mar. 15, 2024

Related U.S. Application Data
(60) Provisional application No. 63/245,302, filed on Sep. 17, 2021.

(51) Int. Cl. B01D 19/00

(52) U.S. Cl. CPC B01D 19/0068; B01D 19/0063

(57) ABSTRACT

A bubble trap includes a body having an interior surface bounding a cavity that extends between an upper end and an opposing lower end, an axis extends centrally through the cavity of the body between the upper end and the lower end, a first plane extends through the body orthogonal to the axis so as to divide the body into an upper body portion and a lower body, the interior surface of the lower body portion having a constant first radius from a fixed first center point, the interior surface of the upper body portion not having a constant radius from a fixed center point. A tubular spout projects into the cavity at the lower end encircles a channel that communicates with the cavity. A liquid inlet port, a liquid outlet port, and a gas outlet port communicate with the cavity.

### CROSS-REFERENCE TO RELATED APPLICATIONS

This application claims the benefit of U.S. Provisional Application No. 63/245,302, filed Sep. 17, 2021, which is incorporated herein by specific reference.

### BACKGROUND OF THE DISCLOSURE

### 1. The Field of the Disclosure

The present disclosure relates to bubble traps for use in removing gas bubbles from a liquid stream and, more particularly, to 3D printed bubble traps and methods of manufacture.

### 2. The Relevant Technology

Bubble traps are commonly used on chromatograph machines for removing gas bubbles from the liquid stream being processed. Typical bubble traps have a cylindrical configuration that includes a top plate, an opposing bottom plate and a cylindrical sleeve that extends therebetween. The bubble trap bounds a cavity through which the liquid stream passes. Specifically, the bottom plate is commonly formed with an inlet for receiving the liquid stream and an outlet for removing the liquid stream. The top plate is commonly formed with a gas outlet. As the liquid stream enters the cavity of the bubble trap, the flow rate of the liquid stream slows allowing gas to escape from the liquid and collect within the cavity. Controlled removal of the collected gas can then be achieved through the gas outlet.

Although conventional bubble traps are effective for their intended purpose, they commonly have significant shortcomings. By way of example, many bubble traps are expensive to make and thus are designed to be reused. For example, the top and bottom plate are commonly made of metal while the sleeve extending therebetween is made of glass. The resulting bubble traps are thus expensive as a result of materials, manufacturing and assembly. Furthermore, reuse of the bubble traps requires cleaning and sterilization which can be expensive, time consuming and labor intensive. In addition, assembling the bubble traps from multiple parts increases the risk of leaking which can result in contamination of the fluid being processed. Forming the bubble trap from multiple parts also increases the formation of creases or cracks where the fluid can stagnate and contaminates can hide.

To avoid leaking or other failure of the bubble traps from elevated gas pressure within the cavity, the bubble traps are often over designed, thereby further increasing the cost while producing bulky and often unwieldy bubble traps. Other bubble traps have been formed from polymeric materials. However, these bubble traps are again typically made from multiple components that must be assembled together and thus suffer many of the above discussed problems.

Accordingly, what is needed in the art are bubble traps that solve one or more of the above discussed problems or shortcomings.

### SUMMARY OF THE DISCLOSURE

A first independent aspect of a bubble trap for removing gas bubbles from a liquid stream includes:
a body having an interior surface bounding a cavity and an opposing exterior surface that extend between an upper end and an opposing lower end, an axis extends centrally through the cavity of the body between the upper end and the lower end, a first plane extends through the body orthogonal to the axis so as to divide the body into an upper body portion that terminates at the upper end and a lower body portion that terminates at the lower end, the interior surface of the lower body portion having a constant first radius from a fixed first center point, the interior surface of the upper body portion not having a constant radius from a fixed center point;
a tubular spout projecting into the cavity from the interior surface of the body at the lower end, the tubular spout encircling a channel that communicates with the cavity;
a liquid inlet port disposed at the lower end of the body and communicating directly with the channel of the tubular spout;
a liquid outlet port disposed at the lower end of the body and communicating with the cavity; and
a gas outlet port disposed at the upper end of the body and communicating with the cavity.

A second independent aspect of a bubble trap for removing gas bubbles from a liquid stream includes:
a body having an interior surface bounding a cavity and an opposing exterior surface that extend between an upper end and an opposing lower end, an axis extends centrally through the cavity of the body between the upper end and the lower end, a first plane extends through the body orthogonal to the axis so as to divide the body into an upper body portion that terminates at the upper end and a lower body portion that terminates at the lower end, the first plane dividing the cavity into an upper cavity portion disposed within the upper body portion and a lower cavity portion disposed within the lower body portion, the lower cavity portion being in a configuration of a portion of a sphere while the upper cavity portion is not in a configuration of a portion of a sphere;
a tubular spout projecting into the cavity from the interior surface of the body at the lower end, the tubular spout encircling a channel that communicates with the cavity;
a liquid inlet port disposed at the lower end of the body and communicating directly with the channel of the tubular spout;
a liquid outlet port disposed at the lower end of the body and communicating with the cavity; and
a gas outlet port disposed at the upper end of the body and communicating with the cavity.

A third independent aspect of a bubble trap for removing gas bubbles from a liquid stream includes:
a body having an interior surface and an opposing exterior surface that extend between an upper end and an opposing lower end, the interior surface bounding a cavity having an ovoid configuration with a single axis of symmetry;
a tubular spout projecting into the cavity from the interior surface of the body at the lower end, the tubular spout encircling a channel that communicates with the cavity;
a liquid inlet port disposed at the lower end of the body and communicating directly with the channel of the tubular spout;
a liquid outlet port disposed at the lower end of the body and communicating with the cavity; and
a gas outlet port disposed at the upper end of the body and communicating with the cavity.

In one alternative exemplary embodiment, the interior surface of the upper body portion is concave.

In another exemplary embodiment, the first center point is disposed at an intersection between the axis and the first plane.

In another exemplary embodiment, a line segment extending along the axis from the first center point to the gas outlet port is longer than a line segment extending along the axis from the first center point to the liquid inlet port.

In another exemplary embodiment, a second plane passes through the axis in parallel alignment with the axis and orthogonal to the first plane, the second plane intersecting with the interior surface of the upper body portion so as to form a first curve along the intersection.

In another exemplary embodiment, the first curve is an arc having a second radius from a fixed second center point that is spaced apart from the first center point.

In another exemplary embodiment, the second radius has a length that is at least 1.2, 1.4, 1.6., 1.8, 2.0, 2.2, 2.4 or 2.6 times longer than a length of the first radius.

In another exemplary embodiment, a second plane passes through the axis in parallel alignment with the axis so as to intersect with the interior surface of the upper body portion along a first arc and an opposing second arc extending from the first plane to the upper end, the first arc having a first radius extending from a first center point and the second arc having a second radius extending from a second center point, the first radius being equal to the second radius but the first center point being spaced apart from the second center point.

In another exemplary embodiment, the lower cavity portion is hemispherical.

In another exemplary embodiment, the body is formed as a single, integral, unitary member as opposed to two or more members connected together.

In another exemplary embodiment, the body, tubular spout, liquid inlet port, liquid outlet port, and gas outlet port are formed as a single, integral unitary member as opposed to two or more members connected together.

In another exemplary embodiment, the body, tubular spout, liquid inlet port, liquid outlet port, and gas outlet port are formed by 3D printing.

In another exemplary embodiment, the only communication with the cavity is through the liquid inlet port, liquid outlet port, or gas outlet port.

In another exemplary embodiment, the body can withstand a pressure with the cavity of at least 200 kPa, 250 kPa, 300 kPa, 350 kPa, 400 kPa, 450 kPa, or 500 kPa without failure of the body.

In another exemplary embodiment, a thickness of the body extending between the interior surface and the exterior surface is in a range between 1 mm and 6 mm with between 1 mm and 4 mm being more common.

In another exemplary embodiment, the upper body portion has a first thickness extending between the interior surface and the exterior surface thereof and the lower body portion a second thickness extending between the interior surface and the exterior surface thereof, the first thickness being the same as the second thickness.

In another exemplary embodiment, the exterior surface of the body has the same configuration as the interior surface of the body.

In another exemplary embodiment, the exterior surface of the body has an ovoid configuration with a single axis of symmetry.

In another exemplary embodiment, the body is transparent or translucent.

In another exemplary embodiment, the body is comprised of a polymer.

In another exemplary embodiment, the liquid inlet port and the liquid outlet port each comprise a tubular stem bounding a port.

In another exemplary embodiment, the axis passes through the liquid inlet port and

the gas outlet port.

In another exemplary embodiment, the axis passes through the gas outlet port and between the liquid inlet port and the liquid outlet port.

Another exemplary embodiment further includes a gas valve coupled to the gas outlet port.

In another exemplary embodiment, a proximity sensor is disposed on or adjacent to the exterior surface of the body.

In another exemplary embodiment, the channel of the tubular spout outwardly flares as it projects into the cavity.

In another exemplary embodiment, the channel of the tubular spout has a central longitudinal axis that is aligned with or extends parallel to the axis of the cavity of the body.

In another exemplary embodiment, the channel of the tubular spout has a central longitudinal axis that extends at an angle that is oblique to the axis of the cavity of the body.

In another exemplary embodiment, the axis of the channel of the tubular spout and the axis of the cavity of the body form an inside angle therebetween that is at 30°, 40°, 50°, 60°, or 70°.

In another exemplary embodiment, the channel of the tubular spout faces outward toward the interior surface of the body and away from the axis of the cavity of the body.

In another exemplary embodiment, the tubular spout has an annular end face disposed within the cavity that encircles the channel.

In another exemplary embodiment, when the axis is vertically aligned, the annular end face is vertically spaced apart from the body by a distance of at least 1 cm, 1.5 cm, 2 cm, 2.5 cm, 3 cm, 4 cm, or 5 cm.

In another exemplary embodiment, the tubular spout further comprises a skirt having an interior surface and an opposing exterior surface that both radially, outwardly flare from the end face to the interior surface of the body.

In another exemplary embodiment, the tubular spout terminates at an annular end face disposed within the cavity and encircling the channel, the end face being disposed within a plane that intersects with the axis of the cavity of the body at an oblique angle.

In another exemplary embodiment, the liquid inlet port projects directly from the tubular spout and is spaced apart from the body.

In another exemplary embodiment, an annular locking sleeve projects from the body and encircles the liquid inlet port and the liquid outlet port.

In a fourth independent aspect, a bubble trap is provided for removing gas bubbles from a liquid stream, the bubble trap including:
a body having an interior surface bounding a cavity and an opposing exterior surface that extend between an upper end and an opposing lower end, an axis extends centrally through the cavity of the body between the upper end and the lower end;
a tubular spout projecting into the cavity from the interior surface of the body at the lower end, the tubular spout encircling a channel that communicates with the cavity, the channel having a central longitudinal axis that is disposed at an angle oblique to the axis of the cavity of the body;
a liquid inlet port disposed at the lower end of the body and communicating directly with the channel of the tubular spout;
a liquid outlet port disposed at the lower end of the body and communicating with the cavity; and
a gas outlet port disposed at the upper end of the body and communicating with the cavity.

In one exemplary embodiment, the channel of the tubular spout radially, outwardly flares along a length thereof.

In a fifth independent aspect, a method for manufacturing a bubble trap for removing gas bubbles from a liquid stream includes:
3D printing a lower body portion having an interior surface and an opposing exterior surface, a removable support structure being simultaneously 3D printed on the exterior surface of the lower body portion so as to provide structural support to the lower body portion, the interior surface of the lower body portion having a configuration of a portion of a sphere;
3D printing on the lower body portion an upper body portion having an interior surface and an opposing exterior surface, the lower body portion and the upper body portion combining to form a body bounding a cavity, the interior surface of the upper body portion being concave but not forming a portion of a sphere;
removing the support structure from the lower body portion after forming the upper body portion; and
curing the body before or after removal of the support structure.

One alternative exemplary embodiment further includes:
the exterior surface of the lower body portion having a configuration of a portion of a sphere; and
the exterior surface of the upper body portion having a convex curvature but not have a configuration of a portion of a sphere.

In another exemplary embodiment, the lower body portion and the upper body portion are printed as a single continuous 3D printing process.

In another exemplary embodiment, the upper body portion is 3D printed without printing a support structure on the interior surface of the upper body portion.

In another exemplary embodiment, the upper body portion is 3D printed without printing a support structure on the exterior surface of the upper body portion.

In another exemplary embodiment, 3D printing the lower body portion further comprises 3D printing a fluid inlet port and a fluid outlet port on the lower body portion.

In another exemplary embodiment, 3D printing the lower body portion further comprises 3D printing a tubular spout on the interior surface of the lower body portion, the tubular spout encircling a channel that is in direct communication with the fluid inlet port.

In another exemplary embodiment, 3D printing the upper body portion further comprises 3D printing a gas outlet port on the upper body portion.

In another exemplary embodiment, a stereolithography (SLA) printer is used in 3D printing the lower body portion and the upper body portion.

It is appreciated that each of the features, elements, methods steps and other aspects set forth above or otherwise disclosed herein can be combined with each of the independent aspects set forth herein.

### BRIEF DESCRIPTION OF THE DRAWINGS

Various exemplary embodiments of the present disclosure will now be discussed with reference to the appended drawings. It is appreciated that these drawings depict only typical exemplary embodiments of the disclosure and are therefore not to be considered limiting of its scope.

FIG. 1 is an elevated front view of an exemplary bubble trap incorporating features of the present disclosure;

FIG. 2 is an elevated left side view of the bubble trap shown in FIG. 1;

FIG. 3 is a top perspective view of the bubble trap shown in FIG. 1;

FIG. 4 is a bottom perspective view of the bubble trap shown in FIG. 1;

FIG. 5 is a cross sectional view of the bubble trap shown in FIG. 1;

FIG. 6 is a perspective view of the cross sectional view shown in FIG. 5;

FIG. 7 is a perspective, cross sectional view of the bubble trap shown in FIG. 1 taken from a plane offset from the central axis;

FIG. 8 is an elevated front view of the lower body portion of the bubble trap shown in FIG. 1 3D printed with a support structure;

FIG. 9 is an elevated front view of the upper body portion 3D printed on the lower body portion shown in FIG. 8;

FIG. 10 is an elevated front view of the bubble trap shown in FIG. 1 coupled with an apparatus and a gas valve;

FIG. 11 is an elevated front view of an alternative exemplary embodiment of the bubble trap shown in FIG. 1;

FIG. 12 is a cross sectional, side perspective view of the bubble trap shown in FIG. 11;

FIG. 13 is a cross sectional, top perspective view of the bubble trap shown in FIG. 11;

FIG. 14 is bottom perspective view of the bubble trap shown in FIG. 11; and

FIG. 15 is a side perspective view of the bubble trap shown in FIG. 11.

### DETAILED DESCRIPTION OF THE PREFERRED EMBODIMENTS

Before describing the present disclosure in detail, it is to be understood that this disclosure is not limited to particularly exemplified apparatus, systems, methods, or process parameters that may, of course, vary. It is also to be understood that the terminology used herein is only for the purpose of describing particular exemplary embodiments of the present disclosure and is not intended to limit the scope of the disclosure in any manner.

All publications, patents, and patent applications cited herein, whether supra or infra, are hereby incorporated by reference in their entirety to the same extent as if each individual publication, patent, or patent application was specifically and individually indicated to be incorporated by reference.

The term “comprising” which is synonymous with “including.” “containing,” or “characterized by,” is inclusive or open-ended and does not exclude additional, unrecited elements or method steps.

It will be noted that, as used in this specification and the appended claims, the singular forms “a.” “an” and “the” include plural referents unless the content clearly dictates otherwise. Thus, for example, reference to a “port” includes one, two, or more ports.

As used in the specification and appended claims, directional terms, such as “top,” “bottom,” “left,” “right.” “up.” “down,” “upper,” “lower,” “proximal,” “distal” and the like are used herein solely to indicate relative directions and are not otherwise intended to limit the scope of the disclosure or claims.

Where possible, like numbering of elements have been used in various figures. Furthermore, multiple instances of an element and or sub-elements of a parent element may each include separate letters appended to the element number. For example, two instances of a particular element “10” may be labeled as “10A” and “10B”. In that case, the element label may be used without an appended letter (e.g., “10”) to generally refer to all instances of the element or any one of the elements. Element labels including an appended letter (e.g., “10A”) can be used to refer to a specific instance of the element or to distinguish or draw attention to multiple uses of the element. Furthermore, an element label with an appended letter can be used to designate an alternative design, structure, function, implementation, and/or embodiment of an element. For example, two alternative exemplary embodiments of a particular element may be labeled as “10A” and “10B”. In that case, the element label may be used without an appended letter (e.g., “10”) to generally refer to all instances of the alternative embodiments or any one of the alternative embodiments.

Various aspects of the present devices and systems may be illustrated by describing components that are coupled, attached, and/or joined together. As used herein, the terms “coupled”, “attached”, and/or “joined” are used to indicate either a direct connection between two components or, where appropriate, an indirect connection to one another through intervening or intermediate components. In contrast, when a component is referred to as being “directly coupled”, “directly attached”, and/or “directly joined” to another component, there are no intervening elements present. Furthermore, as used herein, the terms “connection,” “connected,” and the like do not necessarily imply direct contact between the two or more elements.

Various aspects of the present devices, systems, and methods may be illustrated with reference to one or more exemplary embodiments. As used herein, the terms “exemplary,” “embodiment,” and “exemplary embodiment” mean “serving as an example, instance, or illustration,” and should not necessarily be construed as required or as preferred or advantageous over other embodiments disclosed herein.

Unless defined otherwise, all technical and scientific terms used herein have the same meaning as commonly understood by one of ordinary skill in the art to which the present disclosure pertains. Although a number of methods and materials similar or equivalent to those described herein can be used in the practice of the present disclosure, the preferred materials and methods are described herein.

The present disclosure relates generally to bubble traps for use in removing gas bubbles from a liquid stream and, more particularly, to three dimensional (3D) printed gas bubble traps and methods of manufacture. As will be discussed below in greater detail, the bubble traps disclosed herein can be used in combination with a variety of different apparatus that process liquid streams and where it is desired to remove gas bubbles from such streams. By way of example, the disclosed gas bubble traps can be used in biological processes and equipment, including but not limited to with chromatography systems, bioreactors, homogenizers, cell culture systems and vessels, magnetic bead processing systems for cell therapy, fermenters, fluid management systems, mixers, storage containers and/or other equipment capable of producing, mixing, managing and storing biological reagents and end-products.

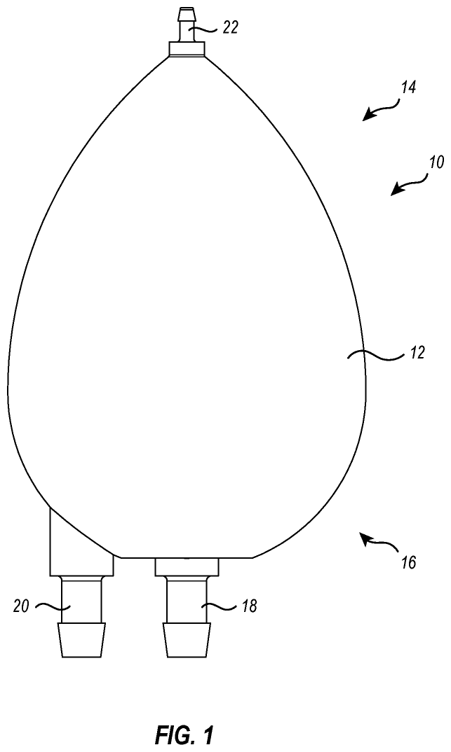

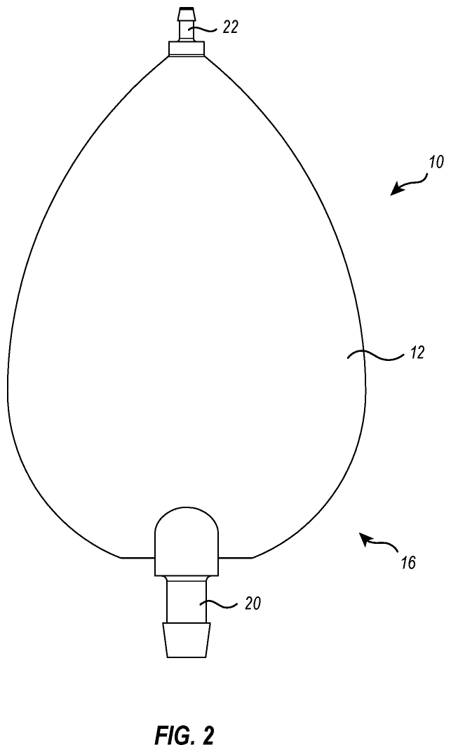

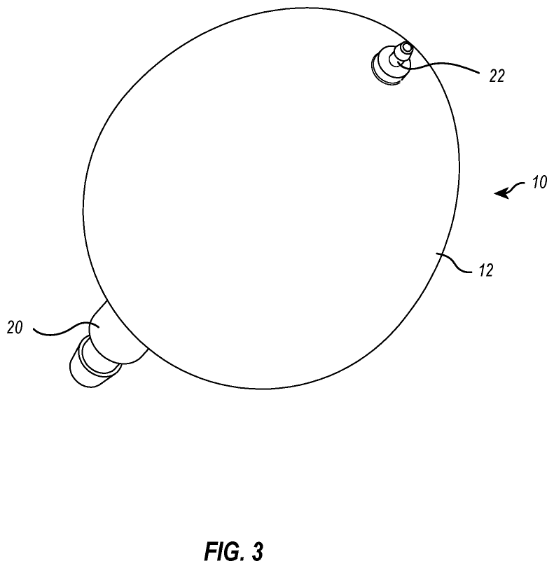

Depicted in FIGS. 1-4 is one exemplary embodiment of a bubble trap 10 incorporating features of the present disclosure. In general, bubble trap 10 can include a body 12 having an upper end 14 and an opposing lower end 16. A liquid inlet port 18 and a liquid outlet port 20 can be disposed at lower end 16 of body 12 while a gas outlet port 22 can be disposed at upper end 14 of body 12.

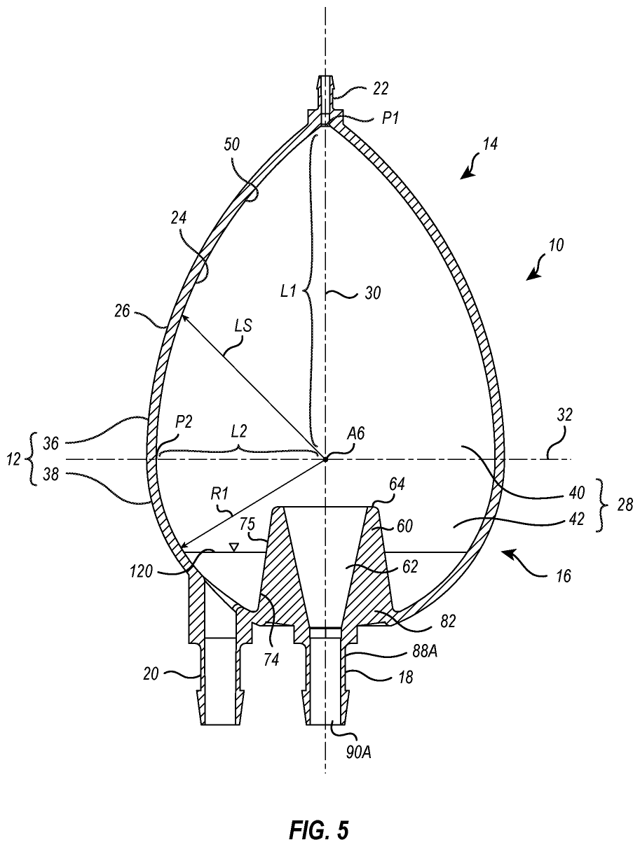

Turning to FIG. 5, body 12 has an interior surface 24 and an opposing exterior surface 26 that both extend between upper end 14 and opposing lower end 16. Body 12 and particularly interior surface 24 thereof bound a cavity 28 that extends between upper end 14 and opposing lower end 16. Each of liquid inlet port 18, liquid outlet port 20, and gas outlet port 22 are disposed so as to communicate with cavity 28.

In one exemplary embodiment, bubble trap 10 or body 12 thereof is configured so that it can be formed by 3D printing as a single, integral, unitary member as opposed to two or more members connected together. For reasons as will be discussed below in greater detail, to accomplish this objective, body 12 is formed having a unique configuration that is at least partially asymmetric. Specifically, in one exemplary embodiment, body 12 can have an axis 30 that centrally extends through cavity 28 of body 12 between upper end 14 and lower end 16. Axis 30 can be a central longitudinal axis and, as discussed below in more detail, can be an axis of symmetry. That is, in one exemplary embodiment body 12 and/or cavity 28 can be symmetrical about axis 30. Although not required, in one exemplary embodiment, axis 30 centrally passes through liquid inlet port 18 at lower end 16 and through gas outlet port 22 at upper end 14. That is, ports 18 and 22 can be aligned at opposing end of body 12. In alternative exemplary embodiments, liquid inlet port 18 and/or gas outlet port 22 can be offset from axis 30 so that axis 30 passes through only one or neither of ports 18 and 22.

A first plane 32 can extend through body 12 orthogonal to axis 30 so as to divide body 12 into an upper body portion 36 that terminates at upper end 14 and a lower body portion 38 that terminates at lower end 16. First plane 32 can also divide cavity 28 into an upper cavity portion 40 disposed within upper body portion 36 and a lower cavity portion 42 disposed within the lower body portion 38. In this exemplary embodiment, upper body portion 36 and lower body portion 38 are not symmetrical about plane 32 and thus have different shapes. Likewise, upper cavity portion 40 and lower cavity portion 42 are not symmetrical about plane 32 and thus have different shapes.

In general terms, interior surface 24 of upper body portion 36 and lower body portion 38 each have a cup shaped configuration, e.g., a three-dimensional concave configuration. More specifically, in one exemplary embodiment interior surface 24 of lower body portion 38, which bounds lower cavity portion 42, has the configuration of a portion of a sphere. Thus, interior surface 24 of lower body portion 38 can have a constant radius R1 from a fixed center point 46. In one exemplary embodiment, center point 46 is located at the intersection between axis 30 and first plane 32 so that interior surface 24 of lower body portion 38 is hemispherical. In alternative exemplary embodiments, center point 46 may be disposed on axis 30 but be offset from first plane 32 so as to form a portion of a sphere that is less than hemispherical.

It is appreciated that bubble trap 10 and body 12 can have a variety of different sizes depending upon their desired application. However, in one exemplary embodiment, radius R1 has a value of at least or less than 4 cm, 6 cm, 9 cm, 10 cm, 12 cm or is in a range between any two of the foregoing values. Other values can also be used. Because of the configuration of interior surface 24 of lower body portion 38, lower cavity portion 42 has the configuration of a spherical dome bounded by first plane 32, i.e., lower cavity portion 42 forms a portion of a sphere cut off by first plane 32. Lower cavity portion 42 can be a hemisphere or less than a hemisphere.

In contrast to interior surface 24 of lower body portion 38 which is in the configuration of a portion of a sphere, interior surface 24 of upper body portion 36 does not have the configuration of a portion of a sphere and is not hemispherical. Likewise, interior surface 24 of upper body portion 36 does not have a constant radius from a fixed center point. Accordingly, upper cavity portion 40 is not hemispherical and does not form a spherical dome. Rather, upper cavity portion 40 bounded by interior surface 24 of upper body portion 36 is elongated along axis 30. More specifically, when measured from center point 46, i.e., the intersection of axis 30 and first plane 32, interior surface 24 of upper body portion 36 has a line segment LS to interior surface 24 that varies over interior surface 24. For example, line segment LS extending from center point 46 along axis 30 to a point P1 where axis 30 intersect with outlet port 22 or interior surface 24 has a length L1 that is longer than a line segment LS having a length L2 extending from center point 46 to a point P2 where first plane 32 intersects with interior surface 24. In some exemplary embodiments, the length L2 of line segment LS is equal to the length of R1. In one exemplary embodiment, length L1 of line segment LS is at least 1.2, 1.4, 1.6., 1.8, 2.0, 2.2, 2.4 or 2.6 times longer than the length L2 of line segment LS or is in a range between any two of the foregoing values. Furthermore, as viewed in FIG. 5, interior surface 24 of upper body portion 36 forms a curve 50 extending from points P2 to P1 wherein the length of line segment LS gradually increases in length along curve 50 as line segment (measured from center point 46) extends from points P2 to P1.

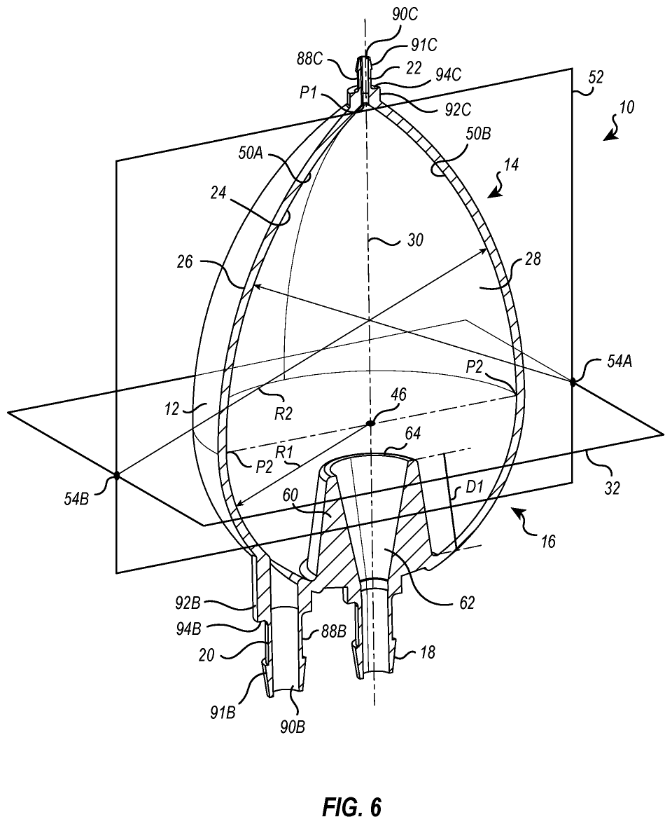

Furthermore, with reference to FIG. 6, in one exemplary embodiment a second plane 52 passes through cavity 28 along and parallel to axis 30 and orthogonally intersects with first plane 32. Second plane 52 intersects with interior surface 24 along opposing curves 50A and 50B each extending between points P1 and P2. Body 12 is configured in this exemplary embodiment so that each curve 50A and 50B is an arc having a constant radius R2 extending between points P1 and P2 from corresponding center points 54A and 54B that are spaced apart. The length of radius R2 can be the same for each arc 50 radially spaced apart around axis 30. However, center point 54 is located at a different location for each arc 50 radially spaced apart around axis 30. Each center point 54 is typically disposed on first plane 32 but is spaced apart from center point 46. The length of radius R2 is typically at least 1.2, 1.4, 1.6., 1.8, 2.0, 2.2, 2.4 or 2.6 times longer than the length of radius R1 or is in a range between any two of the foregoing values.

In view of the foregoing differences between upper body portion 36 and lower body portion 38 and thus the corresponding differences between upper cavity portion 40 and lower cavity portion 42, in one exemplary embodiment cavity 28 and/or body 12 has the configuration of an ovoid wherein axis 30 forms a single axis of symmetry. Benefits of the configuration of body 12 and cavity 28 as discussed above will be discussed below in greater detail.

Although not required, in one exemplary embodiment body 12 has a uniform or substantially uniform thickness extending between interior surface 24 and exterior surface 26. As a result, exterior surface 26 can have the same configuration as interior surface 24, as discussed above. For example, interior surface 23 and exterior surface 26 of body 12 can have the configuration of an ovoid wherein axis 30 forms a single axis of symmetry. Furthermore, exterior surface 26 of lower body portion 38 can have the configuration of a portion of a sphere, such as a hemisphere, while exterior surface 26 of upper body portion 36 is elongated and does not have the configuration of a portion of a sphere. In one exemplary embodiment, the thickness of body 12 between interior surface 24 and exterior surface 26, for both upper body portion 36 and lower body portion 38 is in a range between 1 mm and 6 mm with between 1 mm and 5 mm or between 1 mm and 4 mm being more common. The thickness for both upper body portion 36 and lower body portion 38 can be the same. Other thicknesses can be used depending on the application.

Continuing with FIG. 6, bubble trap 10 can further include a tubular spout 60 projecting into cavity 28 from interior surface 24 at lower end 16. Tubular spout 60 encircles a channel 62 that communicates with cavity 28. Tubular spout 60 has an annular end face 64 disposed within cavity 28 at a termination of channel 62. In one exemplary embodiment, when axis 30 is vertically aligned, annular end face 64 is vertically spaced apart from body 12 by a distance DI of at least or less than 1 cm, 1.5 cm, 2 cm, 2.5 cm, 3 cm, 4 cm, or 5 cm or in a range between any two of the foregoing values. Liquid inlet port 18 is shown projecting directly from tubular spout 60 and is spaced apart from body 12.

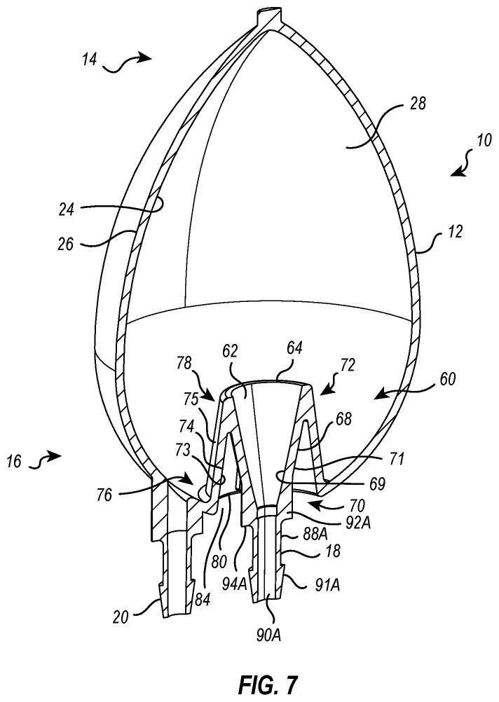

As more clearly shown in the cross-sectional view of FIG. 7, wherein the cross section is taken parallel to but offset from axis 30 (FIG. 6), tubular spout 60 further comprises a tubular sleeve 68 having an interior surface 69 and an opposing exterior surface 71 that extend between a lower first end 70 and an upper second end 72. Liquid inlet port 18 is secured to and outwardly projects from lower first end 70 while second end 72 terminates at annular end face 64. Interior surface 69 of tubular sleeve 68 encircles channel 62 that radially outwardly flares as it extends between first end 70 and second end 72. In one exemplary embodiment, both interior surface 69 and exterior surface 71 radially outwardly flare as they extend between first end 70) and second end 72.

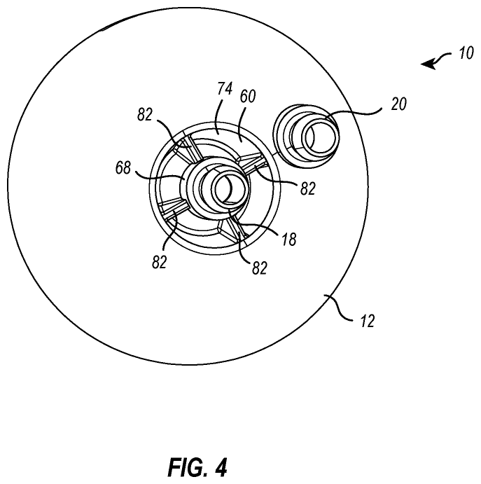

Tubular spout 60 also includes an annular skirt 74 having an interior surface 73 and an opposing exterior surface 75 that extend between a lower first end 76 and an opposing upper second end 78. Lower first end 76 of skirt 74 is secured to body 12 at lower end 16 so as to encircle an opening 84 passing between interior surface 24 and exterior surface 26 of body 12. Sleeve 68 and/or liquid inlet port 18 can pass out through opening 84. Upper second end 78 of skirt 74 projects into cavity 28 and is secured to second end 72 of sleeve 68. Although not required, in the depicted exemplary embodiment both interior surface 73 and exterior surface 75 of skirt 74 radially inwardly flare as they extend from first end 76 to second end 78. An annular slot 80 is bound between exterior surface 71 of sleeve 68 and interior surface 73 of skirt 74. In one exemplary embodiment, slot 80 has a V-shaped transverse cross section. As more clearly shown in FIG. 4, a plurality of spaced apart braces 82 extend between sleeve 68 and skirt 74. In the depicted exemplary embodiment, four braces 82 are used. In other exemplary embodiments, other numbers of braces 82 can be used such as 2, 3, 5 or other numbers. In still other exemplary embodiments, braces 82 can be eliminated. Braces 84 provide support and stability for spout 60 and liquid inlet port 18.

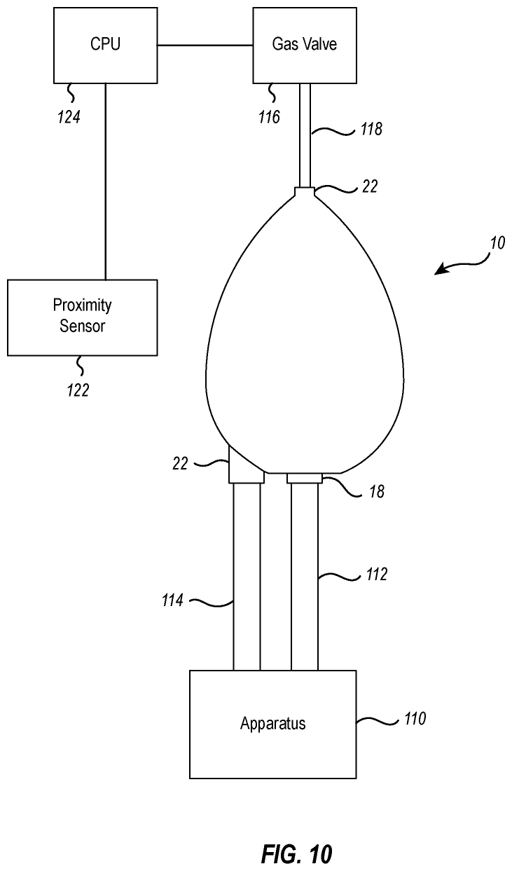

It is appreciated that ports 18, 20, and 22 can have a variety of different configurations and that they are designed so that a tube can be coupled thereto. With reference to FIG. 7, liquid inlet port 18 can comprise a tubular stem 88A that encircles a port opening 90A that communicates directly with channel 62 and thus indirectly communicates with cavity 28. A first end of stem 88A can connect directly with first end 70 of sleeve 68. An optional annular barb 91A encircles an opposing second end of stem 88A. Barb 91A can function to engage a flexible tube that is advanced over stem 88A so as to form a liquid tight seal therewith. An annular base 92A can optionally be formed radially outwardly projecting from the first end of stem 88A. Base 92A adds strength and stability to stem 88A and provides a flat face 94A against which a tube passing over stem 88A can be pushed for proper positioning and engagement, such as shown in FIG. 10. In alternative exemplary embodiments, barb 91A can be replaced with one or more ribs or other types of connects such as a threaded connection, press fit connection, luer lock connector, or the like.

Ports 20 and 22 can have a configuration the same as or similar to liquid inlet port 18. For example, with reference to FIG. 6, liquid outlet port 20 can comprises a tubular stem 88B that encircles a port opening 90B that communicates directly with cavity 28. A first end of stem 88B can connect directly with body 12 at lower end 16 at a location adjacent to spout 60. An optional annular barb 91B encircles an opposing second end of stem 88B. Barb 91B can function to engage a flexible tube that is advanced over stem 88B so as to form a liquid tight seal therewith. An annular base 92B can optionally be formed radially outwardly projecting from the first end of stem 88B. Base 92B adds strength and stability to stem 88B and provides a flat face 94B against which the tube passing over stem 88B can be pushed for proper positioning and engagement. Alternatives discussed above with regard to port 18 are also applicable to port 20.

Likewise, gas outlet port 22 can also comprise a tubular stem 88C that encircles a port opening 90C that communicates directly with cavity 28. A first end of stem 88C can connect directly to body 12 at upper end 14. An optional annular barb 91C encircles an opposing second end of stem 88C. Barb 91C can function to engage a flexible tube that is advanced over stem 88C so as to form a liquid tight seal therewith. An annular base 92C can optionally be formed radially outwardly projecting from the first end of stem 88C. Base 92C adds strength and stability to stem 88C and provides a flat face 94C against which the tube passing over stem 88C can be pushed for proper positioning and engagement. Again, alternatives discussed above with regard to port 18 are also applicable to port 22.

As previously discussed, in one exemplary embodiment bubble trap 10 or body 12 is specifically configured so that they can be formed by 3D printing as a single, integral, unitary member as opposed to two or more members connected together. By 3D printing bubble trap 10/body 12 as a unitary member, bubble trap 10/body 12 can be formed at minimal expense, with minimal labor and with a lower risk of leaking. For example, by configuring bubble trap 10 to be 3D printed as a unitary member, bubble trap 10 can be configured to use minimal material, thereby reducing cost, while simultaneously being designed to withstand desired pressure loads without leaking or failure. Furthermore, by forming bubble trap 10 as a unitary member, assembling or coupling together two or more parts of the bubble trap is eliminated. This simplifies production by eliminating labor for assembly and further minimizes the risk of leaking which most commonly occurs at the joint between the connected parts. In addition, the printed, unitary, bubble trap can be efficiently formed so as to eliminate or minimize creases or cracks (such as where parts are commonly joined together) where bacteria or other contaminates can reside which can contaminate the liquid flowing through the bubble trap. Still further, because the printed bubble traps are relatively inexpensive to make, they can be economically disposed of after a single use, thereby avoiding cleaning and sterilization. In addition to having functional properties, bubble trap 10 is designed having sleek esthetic properties so as to create a unique and pleasing appearance.

From one perspective, it could be desired to produce a bubble trap having a body with a spherical configuration. That is, in general, a spherical geometry is an optimal shape for a pressure vessel. Thus, a bubble trap formed having a spherical body could be optimally formed to minimize material cost. i.e., minimize wall thickness of the body, while maximizing pressure resistance. However, spherical configurations can be difficult to 3D print without adding a support structure within the sphere. For example, in one method of 3D printing a sphere, the sphere is printed from the bottom up. As the lower half of the sphere is being printed, the sphere does not have sufficient structural strength to be self-supporting during printing. As such, a support structure is concurrently printed on the exterior surface of the lower half of the sphere during formation. The support structure provides sufficient structural strength so that the lower hemisphere does not deform or fail during the printing process.

The same problem also occurs as the upper half of the sphere is being printed on the lower hemisphere. However, to support the upper hemisphere, the support structure needs to be concurrently printed on the interior surface of the upper hemisphere, i.e., within the cavity of the sphere. Once the completed sphere has cured, the support structure can be easily removed from the exterior surface of the lower hemisphere. However, it can be very difficult to remove the support structure formed within the cavity. With regard to the bubble trap, in theory, the support structure could be removed from the cavity through one of the ports formed on the body. However, this can be difficult and time consuming to achieve and produces a high risk that portions of the support structure may remain within the cavity. In turn, remnants of the support structure within the cavity could pass out through the liquid outlet port with the liquid being processed, thereby potentially damaging or interfering with operation of the equipment on which the bubble trap is being used and/or interfering with use of the liquid.

To avoid the foregoing problems, exemplary bubble traps 10, as disclosed herein, are configured so as to eliminate the need to print a support structure withing cavity 28 but can still be optimized to minimize material cost while achieving desired pressure levels. For example, as previously discussed, lower body portion 38 of body 12 can be formed with interior surface 24 and exterior surface 26 thereof each having a hemispherical configuration (or a configuration of a portion of a sphere) with a substantially constant thickness extending therebetween. This configuration optimizes the production and pressure capacity for lower body portion 38, as discussed above. Bubble trap 10 can be 3D printed using different printing processes. In one exemplary embodiment, bubble trap 10 is printed using stereolithography (SLA) printing, i.e., using a stereolithography (SLA) printer. Bubble trap 10 can also be made using other types of 3D printing/printers.

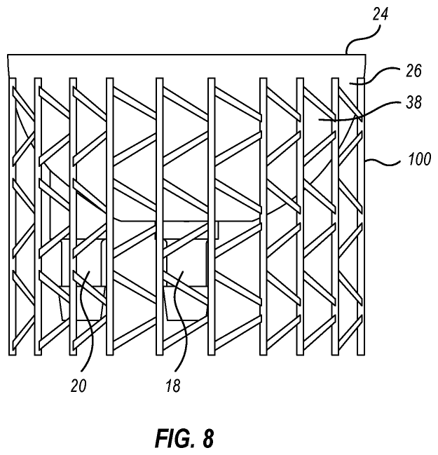

With reference to FIG. 8, in one exemplary embodiment of the 3D printing process, lower body portion 38 is printed with a support structure 100 being concurrently printed on exterior surface 26 thereof. Although support structure 100 can have a variety of different configurations, support structure 100 typically comprises one or more lattice structures that are printed so that a lower end will rest on a support surface of the 3D printer and the opposing upper end integrally connects to exterior surface 26 of lower body portion 38 at predefined, spaced apart locations. Lattice structure(s) 100 is configured and positioned so that lower body portion 38 is supported during the printing process and, if needed, during the subsequent curing process so as to prevent deformation or failure of lower body portion 38. No support structure is printed or otherwise positioned against interior surface 24 of lower body portion 38. Although not required, maintaining constant thickness between interior surface 24 and exterior surface 26 minimizes material cost, simplifies 3D printing, and helps to eliminate distortion due to unequal expansion and contraction of the material having different thicknesses.

Ports 18 and 20 and spout 60 can also be designed to simplify and optimize production by of bubble trap 10 by 3D printing. For example, ports 18 and 20 are formed as simple, cylindrical structures. Spout 60 could be made with slot 80 (FIG. 7) filled with material. However, by forming spout 60 from sleeve 68, skirt 74 and braces 82, each of these structures can be formed as simple structures that each have a thickness that is the same or similar to the thickness of body 12, thereby again minimizing material cost, simplifying 3D printing, and helping eliminate distortion due to unequal expansion and contraction of different parts.

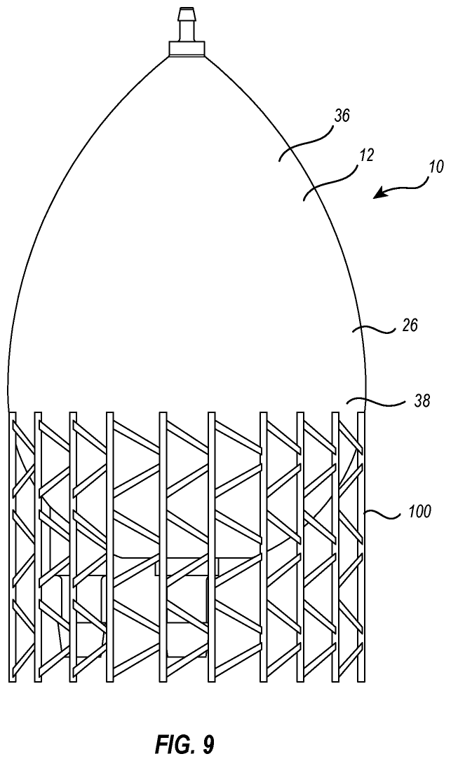

As previously discussed, upper body portion 36 has a non-hemispherical, elongated configuration so as to be self-supporting during 3D printing and subsequent curing, thereby eliminating the need for a supporting structure to me concurrently printed or otherwise positioned or formed within cavity 28 or against interior surface 24. For example, as depicted in FIG. 9, upper body portion 36 and gas outlet port 22 can be 3D printed on top of lower body portion 38 without any support structure being printed or positioned against interior surface 24 or exterior surface 26 of upper body portion 36. All of bubble trap 10 can be 3D printed as a single, continuous printing process.

Depending on the printing process used, once printing of bubble trap 10 with support structure 100 is completed, bubble trap 10 can be rinsed to remove unwanted resin and then cured. Curing is typically achieved by applying UV light either through the application of natural sunlight or through the use of a UV lamp, such as within an enclosed chamber. Depending on the stability of bubble trap 10 after initial printing, support structure 100 can be removed prior to or after the curing step. Support structure 100 can typically be removed manually without the required use of tools or instrument. However, various tools/instruments, such as pliers, can be used to remove support structure 100 from bubble trap 10 so as to produce a smooth, more finished, exterior surface 26. As previously discussed, no removal of a support structure from within cavity 28 is required and there is no risk of any remnant support structure being carried out from cavity 28 by fluid flowing therethrough.

In one exemplary embodiment, bubble trap 10 is made of a polymeric material, such as those commonly used in 3D printing. The polymer can be a medical grade polymer, such as one that can be sterilized by irradiation. In another exemplary embodiment, the polymer can be a transparent or translucent polymer so that the fluid level/fluid flow can be seen within bubble trap 10. For example, bubble trap 10 can be produced from BIOCLEAR. In alternative exemplary embodiments, the material can be opaque and alternative materials can be used.

Once fully formed and cured, bubble trap 10/body 12 can typically withstand a pressure within cavity 28 without leaking and/or failure of at least 200 kPa, 250 kPa, 300 kPa, 350 kPa, 400 kPa, 450 kPa, or 500 kPa or in a range between any two of the foregoing. In another exemplary embodiment, bubble trap 10/body 12 can typically withstand a pressure within cavity 28 without leaking and/or failure of at least 100 psi (689 kPa), 150 psi (1,034 kPa), 200 psi (1,379 kPa), 250 psi (1,724 kPa), 300 psi (2,068 kPa), or 400 psi (2,759 kPa) or in a range between any two of the foregoing. By varying the thickness of body 12, higher pressure values can also be reached.

Turning to FIG. 10, during use bubble trap 10 is coupled to an apparatus 110 having a fluid steam from which gas bubbles must be removed. For example, as previously discussed, in one exemplary embodiment apparatus 110 can comprise a chromatography machine. Bubble trap 10 can also be used with other apparatus as previously discussed. A liquid outlet line 112 extending from apparatus 110 is coupled to liquid inlet port 18 while a liquid return line 114 extending from apparatus 110 is coupled to liquid outlet port 20. A gas valve 116 is coupled to gas outlet port 22 so as to control the flow or release of gas through gas outlet port 22. In one exemplary embodiment, a gas line 118, such as a flexible tube, is coupled 30) with gas outlet port 22 and has gas valve 116 coupled thereto. Gas valve 116 can comprise a pinch valve, solenoid valve, or other conventional gas valves.

With reference to FIGS. 5 and 10, during use bubble trap 10 is vertically orientated, e.g., axis 30 is vertically orientated, with gas outlet port 22 being above liquid inlet port 18. A liquid stream containing gas bubbles flows from apparatus 110 through liquid outlet line 112, liquid inlet port 18 and into channel 62. As a result of channel 62 outwardly flaring, the liquid stream begins to slow as it flows upward through channel 62. The slowing of the liquid stream assists in allowing gas bubbles to escape the liquid stream and enter cavity 28. In addition, the slowing of the liquid stream helps prevent the liquid stream from splashing against or otherwise reaching gas outlet port 22 and thereby helps to prevent any of the liquid stream from passing out through gas outlet port 22. As the liquid stream exits channel 62 it initially flows radially outward over end face 64 and down exterior surface 75 of spout 60/skirt 74. As the liquid flows over end face 64 and down outwardly sloping skirt 74, the gas bubbles are further released from the liquid stream and into cavity 28. However, the configuration of bubble trap 10 and the flow rate of the liquid stream are set so that the liquid stream temporarily pools within cavity 28 and then flows out of cavity 28 through liquid return line 114. Cavity 28 has a height that extends along axis 30 from lower end 16 to upper end 14. The pooled liquid within cavity 28 has a top surface 120 that is disposed at a height level along the height of cavity 28. The height level of top surface 120 varies during operation and depends in part on the gas pressure within cavity 28. That is, as more of liquid stream passes into bubble trap 10, more gas is released into cavity 28 which increases the gas pressure within cavity 28. As the gas pressure increases, the height level of the top surface 120 of the pooled liquid lowers. It is typically desirable for the liquid to temporarily pool within bubble trap 10 to optimize the removal of gas bubbles therefrom.

The height level of top surface 120 and thus the resident time of the liquid within bubble trap 10 can be controlled in a variety of different ways. In one exemplary embodiment, a proximity sensor 122 is positioned adjacent bubble trap 10 so that it can detect the height level of top surface 120. Proximity sensor 122 and gas valve 116 can be electrically coupled to and controlled by a programmable central processing unit (CPU) 124. For example, based on signals generated by proximity sensor 122, CPU 124 determines when the height level of top surface 120 reaches a minimum desired height within cavity 28. CPU 124 then signals to gas valve 116 to temporarily open, thereby allowing a portion of the gas within cavity 28 to escape to the environment. As gas escapes to the environment, the pressure within cavity 28 decreases, thereby causing the height level of top surface 120 of the pooled liquid to rise. A predetermined quantity of gas is released so that the height level of top surface 120 is raised to a maximum desired height. The pressure is then permitted to gradually increase until the height level of top surface 120 again reaches the minimum desired height within cavity 28 and the process is then repeated. The maximum and minimum height level for top surface 120 during operation of bubble trap 10 are typically in a range between 80% and 20% of the height of cavity 28 with between 80% and 40% or between 80% and 60% of the height of cavity 28 being more common. Although bubble trap 10 can operate with the height level of top surface 120 being below end face 64 of spout 60, the height level of top surface 120 is typically above end face 64 of spout 60 during operation.

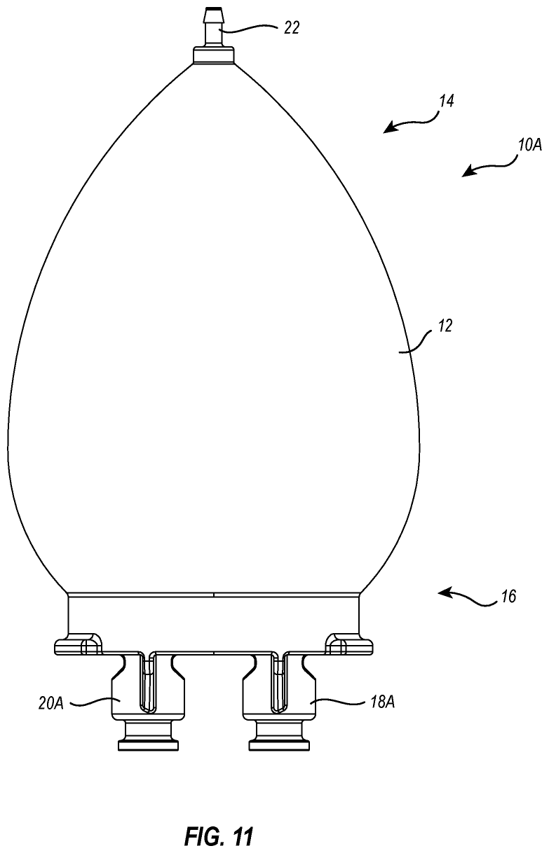

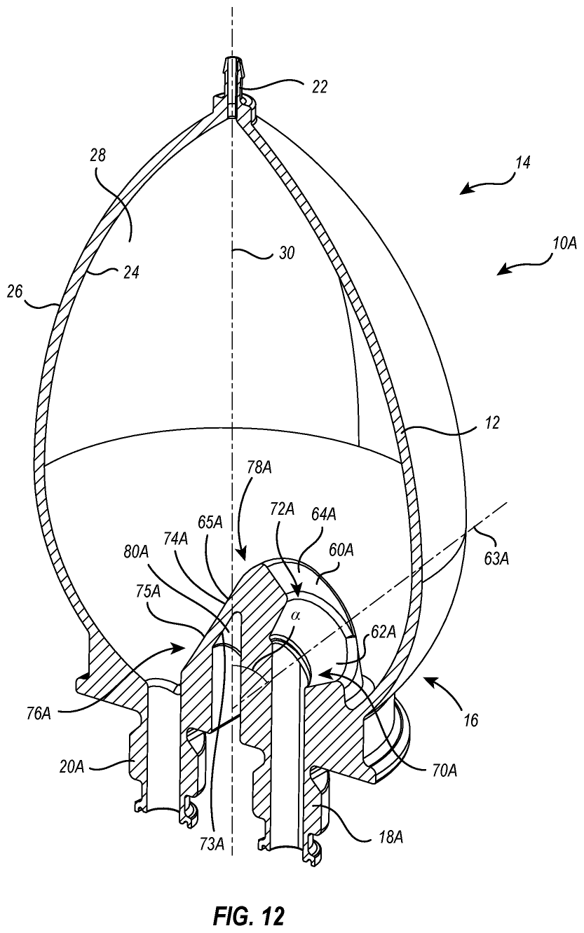

Depicted in FIGS. 11 and 12 is an alternative exemplary embodiment of a bubble trap 10A incorporating features of the present disclosure. Bubble trap 10A has many of the same structural elements as bubble trap 10 and like elements between bubble traps 10 and 10A are identified by like reference characters. Further, the previously discussed materials, alternatives, methods of use, and methods of formation of bubble trap 10 are also applicable to bubble trap 10A and the prior disclosure thereof is incorporated herein for bubble trap 10A.

In general, bubble trap 10A can include body 12 having upper end 14 and opposing lower end 16. A liquid inlet port 18A and a liquid outlet port 20A can be disposed at lower end 16 of body 12 while gas outlet port 22 can be disposed at upper end 14 of body 12. As previously discussed, body 12 has interior surface 24 and opposing exterior surface 26 that both extend between upper end 14 and opposing lower end 16. Body 12 and particularly interior surface 24 thereof bound cavity 28 that extends between upper end 14 and opposing lower end 16. Each of liquid inlet port 18A, liquid outlet port 20A, and gas outlet port 22 are disposed so as to communicate with cavity 28. In contrast to bubble trap 10 where axis 30 passes through both gas outlet port 22 and liquid inlet port 18 (see FIG. 5), both liquid inlet port 18A and liquid outlet port 20A of bubble trap 10A are spaced apart from axis 30. In one exemplary embodiment, axis 30 of bubble trap 10A passes through gas outlet port 22 but is disposed between liquid inlet port 18A and liquid outlet port 20A. More specifically, axis 30 can be centrally disposed between liquid inlet port 18A and liquid outlet port 20A. In this embodiment, ports 18A and 20A are symmetrically formed on body 12.

As with bubble trap 10, in one exemplary embodiment, bubble trap 10A and/or body 12 thereof are configured so that they can be formed by 3D printing as a single, integral, unitary member as opposed to two or more members connected together. As previously discussed, to enable the 3D printing of body 12, body 12 is formed having a unique configuration that is at least partially asymmetric. Again, all of the prior discussion with regard to the configuration, dimensions, method of formation, and alternatives of body 12, as previously discussed with regard to bubble trap 10, are also applicable to body 12 of bubble trap 10A and thus are not repeated.

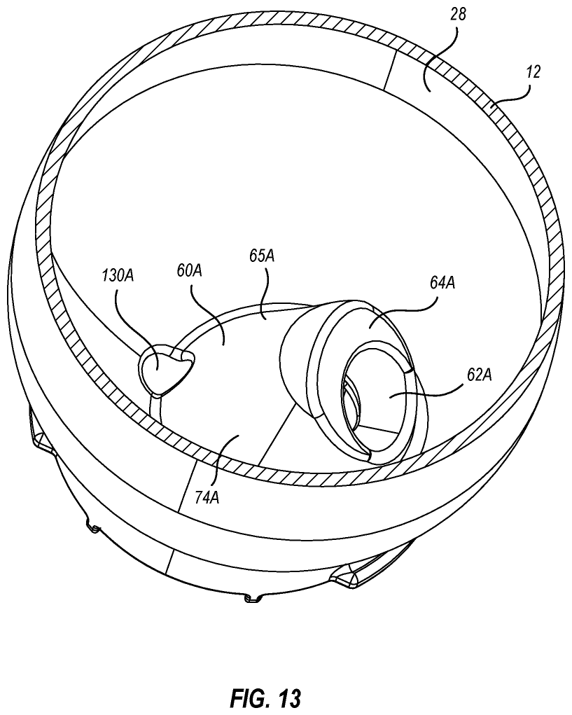

As depicted in FIGS. 12 and 13, bubble trap 10A includes a spout 60A projecting into cavity 28 from interior surface 24 at lower end 16. Spout 60A encircles a channel 62A that communicates with cavity 28 and has a central longitudinal axis 63A. More specifically, spout 60A has an end face 64A within cavity 28 that encircles channel 62A and has an outside face 65A that slopes outward away from end face 64A. In one exemplary embodiment, outside face 65A can have a frustoconical configuration. Channel 62A is orientated so that axis 63A is sloped relative to axis 30, i.e., axis 63A and axis 30 are not disposed in parallel alignment. In one embodiment, axis 63A extends at an oblique angle from axis 30. In other embodiments, axis 63A and axis 30 can form an inside angle α therebetween that is at 30°, 40°, 50°, 60°, or 70° or is in a range between any two of the foregoing. Channel 62A typically faces outward toward interior surface 24 of body 12 and away from axis 30. End face 64A is also typically disposed at an oblique angle relative to axis 30. For example, end face 64A can be disposed in a plane that intersects with axis 30 at an angle in a range between 25° and 65° and more commonly between 30° and 60° or between 35° and 55°. Other angels can also be used.

Channel 62A radially, outwardly flares from a first end 70A that communicates with liquid inlet port 18A to an opposing second end 72A that terminates at end face 64A. As with channel 62 of bubble trap 10, the outward flaring of channel 62A both slows the liquid stream entering from liquid inlet port 18A to help gas bubbles escape and slows the liquid stream to help prevent any liquid from splashing or otherwise reaching gas outlet port 22. The flaring of channel 62A thus helps prevent any of the liquid stream from passing out through gas outlet port 22. Furthermore, in some exemplary embodiments, it can be desirable to improve the mixing of the liquid stream as the liquid stream passes through the bubble trap. The angling of channel 62A, relative to channel 60 of bubble trap 10, helps direct the liquid stream more directly towards inside face 24 of body 12. This directing of the liquid stream helps improve mixing of the liquid stream by increasing the shear force applied to the liquid stream and increasing the turbulence of the liquid stream.

As shown in the FIGS. 12-14, spout 60A also includes an annular skirt 74A having an interior surface 73A and opposing exterior surface 75A that extend between a lower first end 76A and an opposing upper second end 78A. Lower first end 76A of skirt 74A is secured to body 12 at lower end 16 so as to encircle an opening 84A passing through body 12 at lower end 16. Liquid inlet port 18A passes through opening 84A. Although not required, in the depicted exemplary embodiment both interior surface 73A and exterior surface 75A of skirt 74A radially inwardly flare as they extend from first end 76A to second end 78A. An annular slot 80A is bound between liquid inlet port 18A and interior surface 73A of skirt 74A.

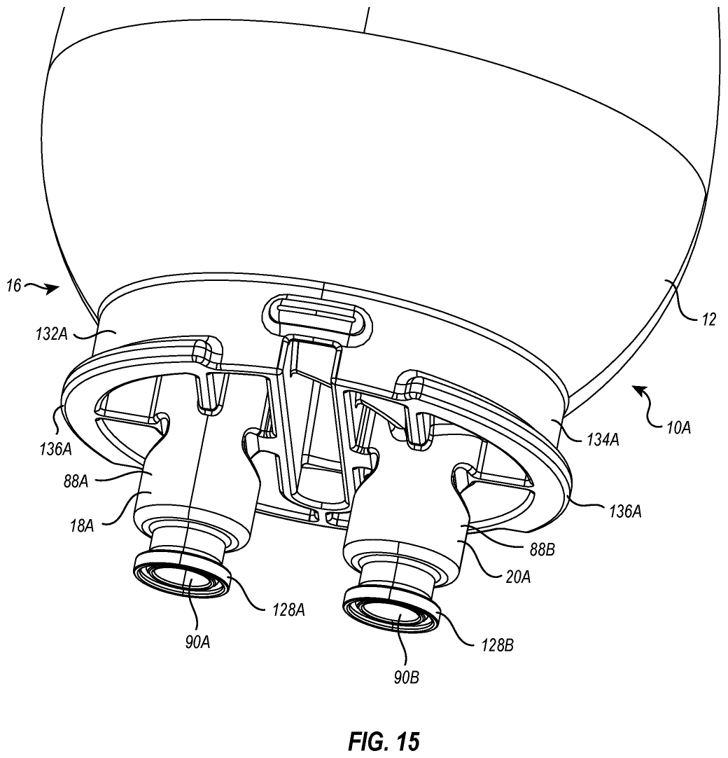

Turning to FIG. 15, liquid inlet port 18A can comprise tubular stem 88A that encircles port opening 90A. Port opening 90A communicates directly with channel 62A (see FIG. 12) and thus indirectly communicates with cavity 28. Liquid inlet port 18A can have the same configuration as liquid inlet port 18 of bubble trap 10. However, in the depicted embodiment, annular barb 91A of bubble trap 10 is replaced with an optional annular flange 128A that encircles and outwardly projects tubular stem 88A. Annular flange 128A is configured to enable a quick coupling with a tube. Other types of couplers can also be used on tubular stem 88A. Liquid outlet port 20A can comprises tubular stem 88B that encircles a port opening 90B. Port opening 90B communicates directly with cavity 28 through an opening 130A (see FIG. 13) extending through body 12 adjacent to or at least partially disposed on spout 60A/skirt 74A. An optional annular flange 128B can also be formed encircling and radially outwardly projecting from the free end of stem 88B that enables a quick coupling with a tube. Again, other types of couplers can also be used.

An annular locking sleeve 132A projects from lower end 16 of body 12 so as to encircle liquid inlet port 18A and a liquid outlet port 20A. Locking sleeve 132A includes an annular sleeve body 134A projecting from lower end 16 of body 12 and one or more locking elements 136A formed on or projecting from sleeve body 134A. In the depicted embodiment, the one or more locking elements 136A comprises a pair of spaced apart flanges outwardly projecting from sleeve body 134A. The flanges can be used for mounting bubble trap 10A on a stand, such as through the use of a twist coupling or through the use of a clamp. Other locking elements such as tabs, threads, snap-fit connectors, bayonet connectors or the like can also be used.

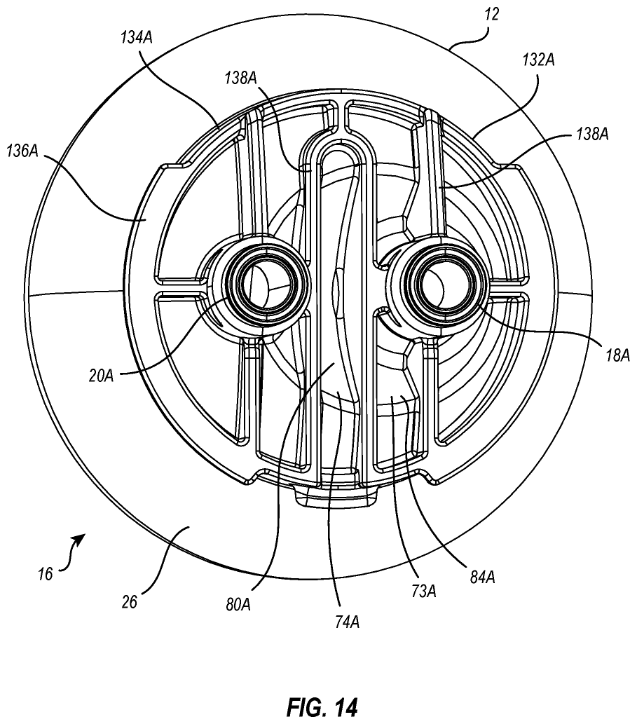

Finally, returning to FIG. 14, a plurality of braces 138A outwardly project from exterior surface 26 of body 12 at lower end 16 and extend between opposing interior sides of locking sleeve 132A. Some of braces 138A intersect with liquid inlet port 18A and/or liquid outlet port 20A. Some of braces 138A also extend into slot 80A bounded by skirt 74A of spout 60A. Braces 138A provide structural support and rigidity to bubble trap 10A.

Again, bubble trap 10A can be formed using 3D printing using the same methods and alternatives as previously discussed with regard to bubble trap 10. Likewise, bubble trap 10A can be used in the same way and with the same alternatives as previously discussed with regard to bubble trap 10. However, bubble trap 10A has increased mixing of the fluid stream and decreased chance of a portion of the fluid stream passing out through gas outlet port 22, relative to bubble trap 10.

Various alterations and/or modifications of the inventive features illustrated herein, and additional applications of the principles illustrated herein, which would occur to one skilled in the relevant art and having possession of this disclosure, can be made to the illustrated exemplary embodiments without departing from the spirit and scope of the invention as defined by the claims, and are to be considered within the scope of this disclosure. Thus, while various aspects and embodiments have been disclosed herein, other aspects and embodiments are contemplated. While a number of methods and components similar or equivalent to those described herein can be used to practice embodiments of the present disclosure, only certain components and methods are described herein.

It will also be appreciated that systems, processes, and/or products according to certain exemplary embodiments of the present disclosure may include, incorporate, or otherwise comprise properties features (e.g., components, members, elements, parts, and/or portions) described in other exemplary embodiments disclosed and/or described herein. Accordingly, the various features of certain exemplary embodiments can be compatible with, combined with, included in, and/or incorporated into other exemplary embodiments of the present disclosure. Thus, disclosure of certain features relative to a specific exemplary embodiment of the present disclosure should not be construed as limiting application or inclusion of said features to the specific exemplary embodiment. Rather, it will be appreciated that other exemplary embodiments can also include said features without necessarily departing from the scope of the present disclosure.

Moreover, unless a feature is described as requiring another feature in combination therewith, any feature herein may be combined with any other feature of a same or different exemplary embodiment disclosed herein. Furthermore, various well-known aspects of illustrative systems, processes, products, and the like are not described herein in particular detail in order to avoid obscuring aspects of the example embodiments. Such aspects are, however, also contemplated herein.

The present disclosure may be embodied in other specific forms without departing from its spirit or essential characteristics. The described exemplary embodiments are to be considered in all respects only as illustrative and not restrictive. The scope of the invention is, therefore, indicated by the appended claims rather than by the foregoing description. While certain exemplary s and details have been included herein and in the attached disclosure for purposes of illustrating exemplary embodiments of the present disclosure, it will be apparent to those skilled in the art that various changes in the methods, products, devices, and apparatus disclosed herein may be made without departing from the scope of the disclosure or of the invention, which is defined in the appended claims. All changes which come within the meaning and range of equivalency of the claims are to be embraced within their scope.

1. (canceled)

2. (canceled)

3. A bubble trap for removing gas bubbles from a liquid stream, the bubble trap comprising:
a body having an interior surface and an opposing exterior surface that extend between an upper end and an opposing lower end, the interior surface bounding a cavity with a single axis of symmetry;
a tubular spout projecting into the cavity from the interior surface of the body at the lower end, the tubular spout encircling a channel that communicates with the cavity;
a liquid inlet port disposed at the lower end of the body and communicating directly with the channel of the tubular spout;
a liquid outlet port disposed at the lower end of the body and communicating with the cavity; and
a gas outlet port disposed at the upper end of the body and communicating with the cavity.

4. (canceled)

5. (canceled)

6. (canceled)

7. (canceled)

8. (canceled)

9. (canceled)

10. (canceled)

11. (canceled)

12. The bubble trap of claim 3, wherein the body is formed as a single, integral, unitary member.

13. The bubble trap of claim 3, wherein the body, tubular spout, liquid inlet port, liquid outlet port, and gas outlet port are formed as a single, integral unitary member.

14. (canceled)

15. The bubble trap of claim 3, wherein the only communication with the cavity is through the liquid inlet port, liquid outlet port, or gas outlet port.

16. (canceled)

17. (canceled)

18. (canceled)

19. The bubble trap of claim 3, wherein the exterior surface of the body has the same configuration as the interior surface of the body.

20. The bubble trap of claim 3, wherein the exterior surface of the body has an ovoid configuration with a single axis of symmetry.

21. (canceled)

22. (canceled)

23. The bubble trap of claim 3, wherein the liquid inlet port and the liquid outlet port each comprise a tubular stem bounding a port.

24. The bubble trap of claim 3, wherein the axis passes through the liquid inlet port and the gas outlet port.

25. The bubble trap of claim 3, wherein the axis passes through the gas outlet port and between the liquid inlet port and the liquid outlet port.

26. The bubble trap of claim 3, further comprising a gas valve coupled to the gas outlet port.

27. The bubble trap of claim 3, further comprising a proximity sensor disposed on or adjacent to the exterior surface of the body.

28. The bubble trap of claim 3, wherein the channel of the tubular spout outwardly flares as it projects into the cavity.

29. The bubble trap of claim 3, wherein the channel of the tubular spout has a central longitudinal axis that is aligned with or extends parallel to the axis of the cavity of the body.

30. The bubble trap of claim 3, wherein the channel of the tubular spout has a central longitudinal axis that extends at an angle that is oblique to the axis of the cavity of the body.

31. (canceled)

32. The bubble trap of claim 30, wherein the channel of the tubular spout faces outward toward the interior surface of the body and away from the axis of the cavity of the body.

33. The bubble trap of claim 3, wherein the tubular spout has an annular end face disposed within the cavity that encircles the channel.

34. (canceled)

35. The bubble trap as recited in claim 33, wherein the tubular spout further comprises a skirt having an interior surface and an opposing exterior surface that both radially, outwardly flare from the end face to the interior surface of the body.

36. The bubble trap of claim 3, wherein the tubular spout terminates at an annular end face disposed within the cavity and encircling the channel, the end face being disposed within a plane that intersects with the axis of the cavity of the body at an oblique angle.

37. The bubble trap of claim 3, wherein the liquid inlet port projects directly from the tubular spout and is spaced apart from the body.

38. The bubble trap of claim 3, further comprising an annular locking sleeve projecting from the body and encircling the liquid inlet port and the liquid outlet port.

39. (canceled)

40. (canceled)

41. (canceled)

42. (canceled)

43. (canceled)

44. (canceled)

45. (canceled)

46. (canceled)

47. (canceled)

48. (canceled)

49. (canceled)
